(19) United States
(12) Patent Application Publication
(10) Pub. No.: US 2019/0309532 A1
(43) Pub. Date: Oct. 10, 2019

(54) SUPPLY SCAFFOLD FOR ARRANGING IN THE INTERIOR OF A TOWER, SCAFFOLD MODULE, TOWER, WIND TURBINE AND METHOD FOR ERECTING AND/OR OPERATING A SUPPLY SCAFFOLD AND FOR ERECTING A TOWER

(71) Applicant: Wobben Properties GmbH, Aurich (DE)

(72) Inventors: Ralf BUCK, Krummhörn (DE); Jan KAPITZA, Großefehn (DE); Rene MEINECKE, Großefehn (DE)

(21) Appl. No.: 16/317,505

(22) PCT Filed: Jul. 17, 2017
(86) PCT No.: PCT/EP2017/068019

§ 371 Date: Jan. 11, 2019

(30) Foreign Application Priority Data
Jul. 20, 2016 (DE) 10 2016 113 350.7

(51) Int. Cl. E04G 1/36; B66B 9/02; E04G 1/15; F03D 13/10

(52) U.S. Cl. CPC E04G 1/36; B66B 9/022; E04G 1/15; F05B 2240/912; E04G 2001/156; F05B 2230/61; F03D 13/10

(57) ABSTRACT

A supply scaffold for arranging in the interior of a tower, in particular in the interior of a tower of a wind power installation, and to a scaffold module for a supply scaffold of said type, and to a tower having a supply scaffold of said type, and to a wind power installation having a tower having a supply scaffold of said type. A method for erecting and/or operating a supply scaffold, and to a method for erecting a tower. The supply scaffold comprises multiple scaffold modules which are arranged one above the other and which are connected to one another, wherein, in the operational state of the supply scaffold, a first scaffold module is formed as a floor module which is arranged so as to stand on a floor, in particular a floor of the tower or a base platform of the tower, and wherein a further scaffold module is formed as a core module, which is arranged on the floor module.

### BACKGROUND

### Technical Field

The invention relates to a supply scaffold for arranging in the interior of a tower, in particular in the interior of a tower of a wind power installation, and to a scaffold module for a supply scaffold of said type, and to a tower having a supply scaffold of said type, and to a wind power installation having a tower having a supply scaffold of said type. The invention also relates to a method for erecting and/or operating a supply scaffold, and to a method for erecting a tower.

### Description of the Related Art

Towers, such as for example television towers or towers of wind power installations, are normally equipped, in the interior thereof, with various tower interior fixtures. Such tower interior fixtures may for example comprise cable arrangements, such as power cables, supply cables or control cables, elevator arrangements, working platforms, ladders or lighting units. Various solutions for the arrangement of tower interior fixtures have been proposed, for example in DE 10 2012 109 860 A1. A disadvantage of existing solutions is however inter alia the fact that, during the erection of the tower, the tower interior fixtures cannot yet be utilized, and/or the arrangement of said tower interior fixtures impedes the erection and/or the operation of the tower (for example the operation of a wind power installation), and/or said tower interior fixtures are restricted to particular tower types.

There is a desire in the art to reduce or eliminate one or more of the stated disadvantages. In particular, there is a need in the art that permits a functional provision of tower interior fixtures during the erection and/or the operation of a tower.

In the priority application relating to the present application, the German Patent and Trade Mark Office performed a search on the following prior art: DE 10 2008 055 607 A1, DE 10 2012 109 860 A1, FR 2 468 541 A1, FR 1 417 198 A, WO 92/18 412 A1, WO 2008/000 565 A2, WO 2009/000 060 A1.

### BRIEF SUMMARY

Provided is a supply scaffold for arranging in the interior of a tower, in particular in the interior of a tower of a wind power installation, having multiple scaffold modules which are arranged one above the other and which are connected to one another, wherein, in the operational state of the supply scaffold, a first scaffold module is formed as a floor module which is arranged so as to stand on a floor, in particular a floor of the tower or a base platform of the tower, and wherein a further scaffold module is formed as a core module, which is arranged on the floor module.

The invention is based inter alia on the realization that existing solutions provide the attachment of tower interior fixtures to the tower wall, and/or can be utilized only after the erection of the tower has been completed, such as for example a supply scaffold suspended on an upper end of the tower. In particular, it is common that tower interior fixtures such as an elevator can be utilized only when the tower has already been fully erected, or at least substantially erected. The invention is furthermore based on the realization that it is advantageous if the supply scaffold and the tower interior fixtures arranged therein are operationally ready already during the erection of the tower, and can in particular be utilized for the further erection of the tower.

For this purpose, the invention provides a supply scaffold which is suitable for arranging within an interior of a tower and which has multiple scaffold modules arranged one above the other and connected to one another. A first, preferably lower, scaffold module is in this case formed as a base module, which is arranged so as to stand on a floor. The base module may for example be arranged on a tower foundation, on a floor forming a base platform in the interior of the tower, or else on a platform which creates a base for the further construction of the tower, such as for example an electrical module arranged in the tower foot.

A further scaffold module is designed as a core module and is arranged on the floor module, in particular likewise so as to stand thereon. Further scaffold modules, in particular scaffold modules designed as core modules, can be arranged one above the other on the first core module, which is arranged on the floor module.

An advantage of the supply scaffold is that the standing arrangement of multiple scaffold modules arranged one above the other on a floor in the operational state of the supply scaffold makes it possible for a functional and operationally ready supply scaffold to be provided already in the presence of a minimal height of the tower (ultimately starting from the time at which a floor is provided), which supply scaffold can be operated independently of the degree of completion, in particular independently of a height, of the tower. Here, the operation of a supply scaffold is to be understood in particular to mean the use thereof for the purposes of supply to the tower and/or parts thereof and/or for the assembly of the tower, for example tower interior fixtures of any type.

The supply scaffold is preferably substantially self-supporting, in the sense that the supply scaffold can transmit its inherent weight and payload substantially through its own structure onto the floor. In particular, the supply scaffold does not need suspended fastening of the supply scaffold. If fastenings of the supply scaffold in an (inter alia) horizontal direction are to be provided, these preferably contribute merely to the lateral stabilization of the supply scaffold, in particular in the case of a large height of the supply scaffold, but preferably do not serve primarily for the dissipation of the inherent weight and payload of the supply scaffold.

In particular in relation to a distributed routing of cables, for example, in the region of a ladder provided for example on the tower interior wall, the provision of a supply scaffold has the advantage that coverage of elements and fixtures, which are in part relevant with regard to maintenance, on the tower interior wall by supply elements such as cables can be avoided, because said cables can be led upward on the supply scaffold. The separation of, for example, power cables and supply lines is also easily possible by means of the supply scaffold. Furthermore, the supply scaffold can improve the accessibility to various elements in the tower interior.

The supply scaffold in particular also has the advantage of a uniform design for a multiplicity of installation types. Irrespective of, for example, a height and/or taper and/or material of the tower (for example steel or concrete tower), the same supply scaffold can be used as long as a minimum space required for the supply scaffold, for example in the form of a minimum diameter, is available. In particular, the supply scaffold can make it possible for further tower segments to be added, and thus for the tower to be built up, in particular by mounting of new tower segments onto the upper end of the tower being assembled. This can eliminate or at least reduce the need to use platforms and/or lifting platforms arranged on the tower wall or on a crane. Also, relatively new external tensioning methods for concrete towers with tensioning cables running in the tower interior can be advantageously used with the supply scaffold, because, by means of a concentration of tower interior fixtures and supply elements on the supply scaffold, more space is available for the arrangement of the tensioning cables, and/or the outlay for the arrangement and/or routing of said tensioning cables can be reduced. Furthermore, more space is also available for other tower interior fixtures and supply elements which are not to be arranged on the supply scaffold.

In a preferred further development, provision is made for the supply scaffold to be designed and arranged so as to be operated during the erection of a tower. The provision of a supply scaffold in an operationally ready state has the advantage inter alia that a supply is possible via the tower interior, specifically by means of the supply scaffold, even already at the assembly stage of the tower, and it is thus at least partially possible to dispense with the additional provision of supply means, for example via an external crane.

In a further preferred embodiment, provision is made for the supply scaffold to be designed and arranged to be operated at varying heights, in particular through the addition of further core modules, in particular in a manner adapted to a respective state of the erection of the tower.

The advantages of such a refinement, which can also be referred to as “joint growth”, are inter alia that the supply scaffold can be adapted to the respective height of the tower in its respective assembly state, whereby, in particular, a supply can be provided, at least partially, even to a respective upper end of a tower, preferably by means of the supply scaffold.

A preferred refinement furthermore provides for one or more scaffold modules, preferably all scaffold modules, to have a framework-like lattice structure. A framework structure design of the scaffold modules has the advantage inter alia of a particularly lightweight and sturdy construction.

The scaffold modules, in particular the base module and/or the core modules, preferably have a substantially cuboidal, cubic or cylindrical basic shape. It is furthermore preferable for the scaffold modules, in particular the base module and/or the core modules, to have a longitudinal extent and/or longitudinal axis which is oriented substantially vertically in the operational state.

It is furthermore preferable for the floor module and/or one or more core modules to have an open sidewall. A sidewall of the floor module and/or of the core modules is or are preferably regarded as that sidewall or those sidewalls which run(s) substantially parallel to the longitudinal extent and/or longitudinal axis. In general, a floor and a top of the scaffold modules run orthogonally with respect thereto. The sidewalls of the scaffold modules are preferably formed substantially by a framework-like lattice structure.

Floors and/or tops of the scaffold modules are preferably of open form in order to create an interior of the supply scaffold which is substantially continuous in a substantially vertical direction.

By contrast, an at least partially open sidewall refers to an embodiment in which the entire sidewall or at least a portion thereof has no lattice structure, but rather either the entire sidewall is of fully open form, or else an opening is provided in the sidewall, which opening is not part of the framework-like lattice structure but rather constitutes an opening without a framework-like lattice structure, that is to say an opening which interrupts the framework-like lattice structure.

In a further preferred refinement, provision is made for one or more core modules to be designed such that all of the sidewalls are closed. A closed sidewall is to be understood in particular to mean a sidewall which has a substantially continuous, framework-like lattice structure at all sidewalls.

In the case of a substantially cuboidal basic shape of the scaffold modules, an open design of a scaffold module thus means that at most three sidewalls are of closed form, whereas a closed form of the core module means that all four sidewalls are of closed form. A scaffold module preferably has multiple open and multiple closed core modules, wherein it is furthermore preferable for the open core modules to be spaced apart from one another by one or more closed core modules. The floor module may preferably be of open or closed form.

Open scaffold modules have the advantage of providing easy access into the interior of the supply scaffold. The size of a scaffold module preferably corresponds to the height of a tower segment or tower ring portion, or to a multiple thereof. It is however also possible for multiple scaffold modules arranged one above the other to together corresponding to the height of a tower segment or tower ring portion.

In particular in the case of a small height of the scaffold modules, it may also be preferable for two or more scaffold modules of open form to be arranged one above the other in order to realize an altogether taller opening in the region of one sidewall (for example two open sidewalls one above the other).

A further preferred refinement provides for the supply scaffold to have a ladder. The ladder is preferably arranged and designed for enabling persons to climb. The ladder is preferably arranged and designed such that persons can climb up or down the ladder on an outer side of the supply scaffold. This is advantageous in particular if—as will be described in more detail below—an elevator is arranged in the interior of the supply scaffold.

The provision of a ladder on the supply scaffold has the advantage inter alia that—for example in relation to a ladder being installed on the tower wall—a collision with tensioning cables and other fixtures on the tower wall can be avoided. Furthermore, in the case of towers which taper in an upward direction, the arrangement of the ladder on the supply scaffold rather than on the tower interior wall has the effect that a negative climbing angle of the ladder, which in accordance with relatively new standards is inadmissible, is avoided. Altogether, through the arrangement of the ladder on the supply scaffold, it is possible for time and costs to be saved.

Furthermore, a refinement is particularly preferred in which one sidewall of the supply scaffold is equipped with a framework-like lattice structure which has the form of a ladder. This may be realized for example by virtue of the framework-like lattice structure on the sidewall which is intended to form the ladder having a multiplicity of horizontal rungs, wherein said rungs preferably have a vertical spacing to one another which is suitable and/or approved for a ladder for persons.

It is furthermore preferable for the supply scaffold to have a climbing aid. The climbing aid may for example be in the form of a rail into which a strap element worn by the person climbing can be clamped. The climbing aid is preferably designed to make it easier for the person climbing to climb through the application of an at least partially upwardly directed pulling force. For this purpose, the climbing aid may preferably have a drive and/or various cable arrangements, such as for example supply cables and/or safety ropes. The advantage of the embodiment of a climbing aid on the supply scaffold is that, for example, a drive and/or cable arrangements of the climbing aid can be easily attached to and carried along on the supply scaffold.

In a particularly preferred refinement, the climbing aid is arranged on that sidewall of the supply scaffold which has the framework-like lattice structure which has the form of a ladder. It is furthermore particularly preferable for the climbing aid to be provided on the sidewall on the ladder, in particular in the center of the ladder. Such an arrangement of the climbing aid may be provided such that the rungs of the ladder are divided centrally by the climbing aid. An arrangement of the climbing aid on a sidewall formed as a ladder has the advantage that, on the ladder, additional cable arrangements for the climbing aid can be omitted, because these can be attached for example to the other sidewalls of the supply scaffold.

In a further preferred refinement, provision is made for the supply scaffold to have an elevator module. The provision of an elevator module, in particular in the interior of the supply scaffold, has the major advantage that the supply scaffold can be utilized for vertical transport of persons and/or loads, such as for example working, tools, etc., in particular even already during the erection of the tower, because the supply scaffold is already operationally ready even in the assembly state of the tower.

The elevator module is preferably arranged in an interior of the supply scaffold, in particular in an interior of the scaffold modules. In this way, a particular space-saving arrangement can be realized.

It is furthermore preferable for the elevator module to be arranged and designed such that persons and/or loads can be conveyed in the interior of the scaffold modules by means of the elevator module. A conveying direction of the elevator module runs preferably in a substantially vertical direction. It is furthermore preferable for the elevator module to be arranged and designed to convey persons and/or loads at varying heights.

In a further preferred refinement, provision is made for the supply scaffold, in particular the scaffold module, to have a riser device, which engages with a riser element of the elevator module. It is particularly preferable that the elevator module makes do without a suspension of the elevator module arranged vertically above the elevator module. The supply scaffold preferably has a drive which drives the riser device and/or the riser element. The drive may preferably be arranged on or in the elevator module, or for example on or in the base module. These arrangements have the advantage that the drive of the elevator module is independent of the height of the (jointly growing) supply scaffold, and also the elevator module is thus operationally ready at varying heights of the (jointly growing) supply scaffold or at varying heights of the tower.

The elevator module furthermore has the advantage that the suspension means for the tower elevators that are conventionally required for tower elevators at the upper end of the tower, for example in the form of lift or elevator beams, are not required here.

The drive of the riser device and/or of the riser element sets the elevator module preferably in substantially vertical motion in order to convey persons and/or loads.

The riser device preferably comprises a toothed rack. The riser element is preferably in the form of a toothed wheel. This refinement has the advantage of being particularly reliable and robust, and furthermore easy to lengthen in terms of height. The toothed rack is preferably arranged substantially vertically, and furthermore preferably on a sidewall of the supply scaffold. The toothed wheel is preferably connected to said toothed rack. A drive arranged preferably on the elevator module sets, for example, the toothed wheel in rotational motion and thus, via the engagement with the toothed rack, sets the elevator module in substantially vertical motion.

A longitudinal extent of the elevator module is preferably smaller than or equal to a longitudinal extent of a scaffold module. The elevator module preferably has a boarding opening, the longitudinal extent and/or transverse extent of which are/is smaller than or equal to a longitudinal extent and/or a transverse extent of an open sidewall of a scaffold module. This refinement has the advantage that the open sidewall of a scaffold module can be utilized for boarding or disembarking from the elevator module.

In a further preferred refinement, provision is made for the supply scaffold, in particular one or more core modules and/or the base module, to have one or more first fastening elements for fastening the supply scaffold to the tower, in particular to a tower interior wall.

In particular, the fastening of the supply scaffold (at least inter alia) in a horizontal direction may be preferable in particular with increasing height of the supply scaffold.

Furthermore, a refinement is preferred in which the supply scaffold, in particular one or more scaffold modules, has one or more second fastening elements for fastening supply elements, such as for example cable arrangements, to the supply scaffold, preferably to a sidewall. The second fastening elements may face toward the interior of the supply scaffold or may be arranged on an outer side of the supply scaffold. The second fastening elements are in particular designed for fastening cables, preferably individual or multiple cables, cable guides, cable rails, etc., to the supply scaffold, in particular in the case of a substantially vertical profile of the supply elements.

A further preferred refinement provides for the supply scaffold to have a platform, which is preferably arranged displaceably, in particular in a substantially vertical direction, on the supply scaffold. The platform extends preferably in a substantially horizontal direction and furthermore preferably so as to be substantially averted from the interior of the supply scaffold, that is to say on outer sides of the sidewalls. It is furthermore preferable for a substantially vertical guide of the platform to be provided on the supply scaffold in order to be able to vary the height of the platform. It is furthermore preferable for a substantially horizontal extent of the platform to be variable in order to be able to adapt the platform, in particular also in the case of varying height, to varying tower inner diameters.

According to a further aspect of the invention, the object stated in the introduction is achieved by means of a scaffold module for a supply scaffold described herein, wherein the scaffold module is characterized in that the scaffold module is a floor module, which is designed to be arranged so as to stand on a floor, in particular a floor of the tower or a base platform of the tower, in the operational state of the supply scaffold, or is a core module, which is designed to be arranged on a floor module in the operational state of the supply scaffold.

According to a further aspect of the invention, the object stated in the introduction is achieved by means of a tower, in particular a tower for a wind power installation, which comprises a supply scaffold described herein and/or a scaffold module described herein.

According to a further aspect of the invention, the object stated in the introduction is achieved by means of a wind power installation which comprises a tower described herein and/or a supply scaffold described herein and/or a scaffold module described herein.

According to a further aspect of the invention, the object stated in the introduction is achieved by means of a method for erecting and/or operating a supply scaffold, in particular a supply scaffold described herein, comprising arranging a scaffold module designed as a floor module so as to stand on a floor, in particular a floor of the tower or a base platform of the tower, arranging a scaffold module designed as a core module on the floor module, and setting the supply scaffold in operation.

According to a further aspect of the invention, the object stated in the introduction is achieved by means of a method for erecting a tower, in particular a tower for a wind power installation, comprising providing a tower foot having a floor or having a base platform, erecting and operating a supply scaffold described herein in accordance with the method described herein, and erecting a tower on the tower foot.

With regard to the advantages, design variants and design details of these further aspects of the invention, and the respective further developments thereof, reference is made to the above description relating to the corresponding features of the supply scaffold.

### BRIEF DESCRIPTION OF THE SEVERAL VIEWS OF THE DRAWINGS

Preferred embodiments of the invention will be described by way of example on the basis of the appended figures, in which:

FIG. 1 is a schematic illustration of a wind power installation;

FIG. 2 shows a three-dimensional view of a first exemplary embodiment of a supply scaffold;

FIG. 3 shows the arrangement of the supply scaffold as per FIG. 2 on a tower foot;

FIG. 4 shows the arrangement of the supply scaffold as per FIG. 2 on an electrical module arranged on a tower foundation;

FIG. 5 shows a three-dimensional view of a scaffold module of open form of the supply scaffold as per FIG. 2;

FIG. 6 shows a three-dimensional view of a scaffold module of closed form of the supply scaffold as per FIG. 2;

FIG. 7 shows a three-dimensional view of a scaffold module of closed form of the supply scaffold as per FIG. 2, with cable arrangements;

FIG. 8 shows a detail from FIG. 7 without cable arrangements;

FIG. 9 shows a three-dimensional view of an elevator module of the supply scaffold as per FIG. 2;

FIG. 10 shows a detail of a three-dimensional view of a supply scaffold arranged on a tower foot, with a platform;

FIG. 11 shows a three-dimensional view of a further embodiment of a supply scaffold; and

FIG. 12 shows a three-dimensional view of a scaffold module of open form with an elevator module as per FIG. 11.

### DETAILED DESCRIPTION

Identical or substantially functionally identical or similar elements are denoted in the figures by the same reference designations.

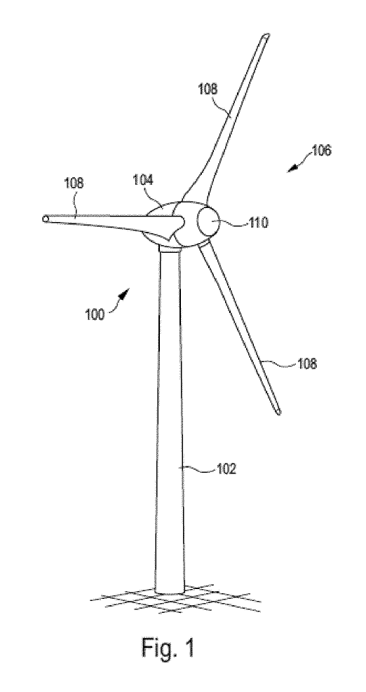

FIG. 1 shows a wind power installation 100 having a tower 102 and a nacelle 104. A rotor 106 with three rotor blades 108 and with a spinner 110 is arranged on the nacelle 104. The rotor 106 is, during operation, set in rotational motion by the wind, and thus drives a generator in the nacelle 104.

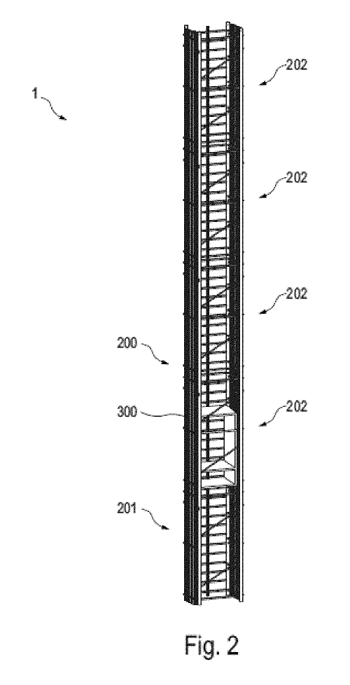

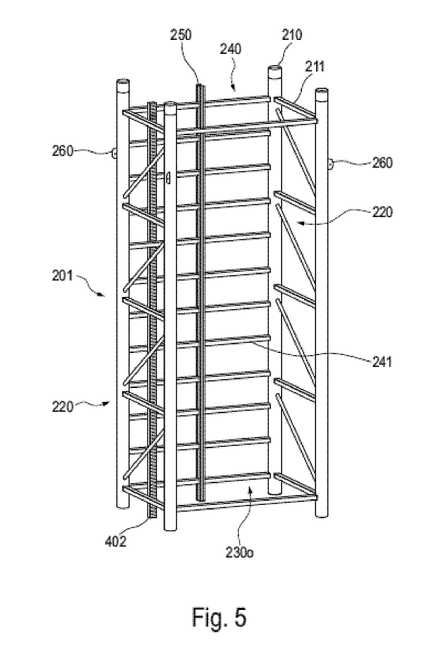

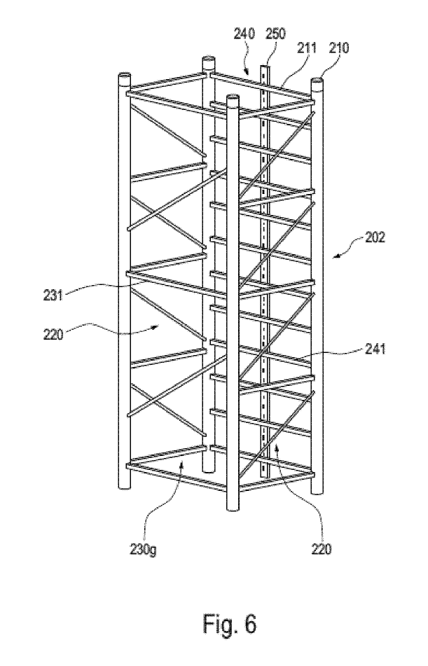

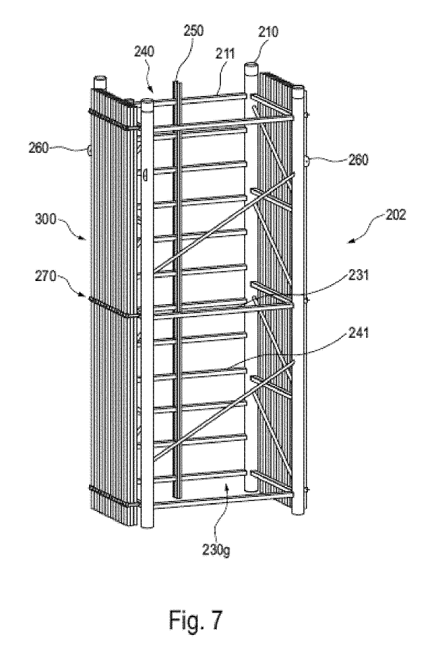

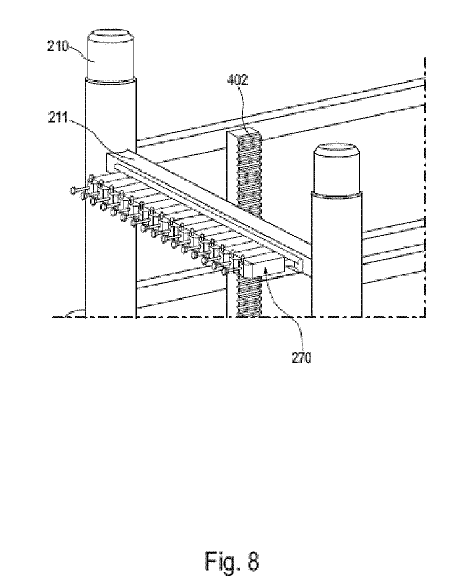

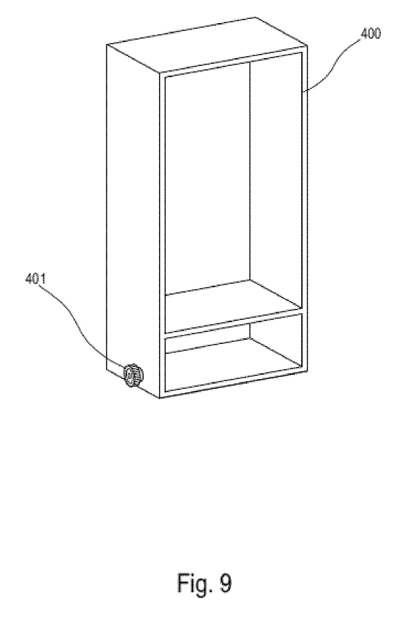

In the interior of the tower 102, preferably even already during the erection of the tower 102, there is arranged a supply scaffold 1 illustrated in FIGS. 2-12.

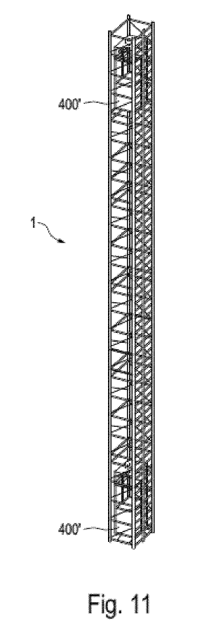

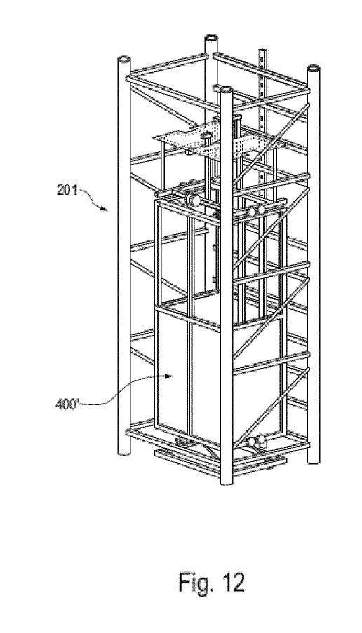

FIGS. 2-10 illustrate a first exemplary embodiment of a supply scaffold 1. FIGS. 11-12 illustrate a further exemplary embodiment of a supply scaffold 1, which differs from the supply scaffold 1 illustrated in FIGS. 2-10 substantially by a different elevator module. Unless stated otherwise, the following statements apply to both variants of the supply scaffold 1.

The supply scaffold 1 comprises multiple scaffold modules 200 which are arranged one above the other and connected to one another. The scaffold modules each have four corner struts 210 and transverse struts 211 which connect the corner struts 210 at the upper and lower end. As can be seen in the figures, the scaffold modules 200 have a framework-like lattice structure.

The first, lower scaffold module is in the form of a base module, which is arranged so as to stand on a floor. The further scaffold modules are in the form of core modules, and are arranged on the floor module, likewise in a standing manner.

The scaffold modules 200, in particular the base module and/or the core modules, have a substantially cuboidal basic shape with a longitudinal extent and/or longitudinal axis oriented substantially vertically in the operational state.

First fastening elements 260, which in this case are arranged on the corner struts 210, serve for fastening the supply scaffold 1 (at least partially inter alia) in a horizontal direction, for example to a tower interior wall, and serve preferably merely for positional stabilization in a substantially horizontal direction.

The scaffold modules 200 may be in the form of an open scaffold module 201 or as a closed scaffold module 202. In the exemplary embodiments illustrated, the open scaffold modules 201 have one fully open sidewall 230o. In the case of the closed scaffold modules 202, that sidewall 230g which in the case of the open scaffold modules 201 is of open form has a centrally arranged transverse strut 231, and is thus closed. As can be seen in FIGS. 11 and 12, the open sidewall 230o serves in particular for boarding and disembarking from an elevator module.

The elevator module 400 illustrated in the exemplary embodiment of FIGS. 2-10 has a riser element in the form of a toothed wheel 401, which in the operational state engages with a riser device arranged on the rear sidewall 240, which riser device is in this case in the form of a toothed rack 402. By means of a drive action, preferably of the toothed wheel 401, it is thus possible to realize a substantially vertical movement of the elevator module 400 in order to convey persons and/or loads in the interior of the supply scaffold 1. The drive of the toothed wheel 401 may preferably be arranged on the elevator module 400.

The elevator module 400′ illustrated in FIGS. 11 and 12 serves substantially the same purpose as the elevator module 400 illustrated in FIGS. 2-10. FIG. 11 illustrates the elevator module 400′ in two different positions (at the lower end and at the upper end of the supply scaffold 1). The elevator module 400′ also preferably has a riser element (not illustrated) which engages with a riser device (not illustrated) in order to realize the substantially vertical movement of the elevator module 400′.

The two narrow sidewalls 220 have a framework-like lattice structure both in the open embodiment and in the closed embodiment of the scaffold modules 200. Second fastening elements 270 arranged on the narrow sidewalls 220 serve for receiving cable arrangements 300. The function and design of the narrow sidewalls 220 and of the wide sidewalls 230o, 230g, 240 may also be interchanged, that is to say a wide sidewall may serve for the arrangement of cable arrangements, whereas one of the narrow sidewalls may be in the form of a ladder and the other narrow sidewall may be of open or closed form. Further corresponding variations are possible.

The rear wide sidewall 240 likewise has a framework-like lattice structure both in the open and in the closed embodiment of the scaffold modules 200, but said structure has transverse struts 241 which have a rung spacing in a substantially vertical direction, which are suitable and/or approved for the use of the sidewall 240 as a ladder. The rungs 241 are divided centrally by a climbing aid 250, which may be formed for example from two C shaped profiles.

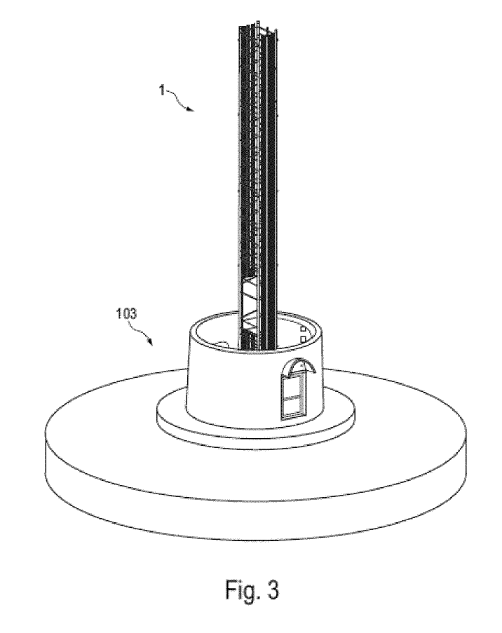

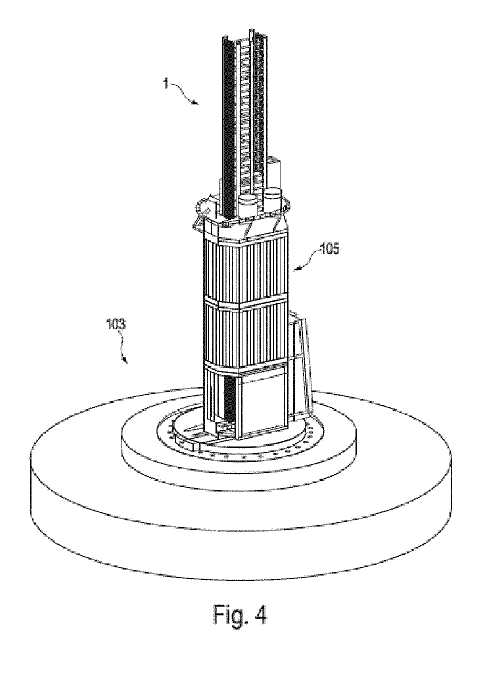

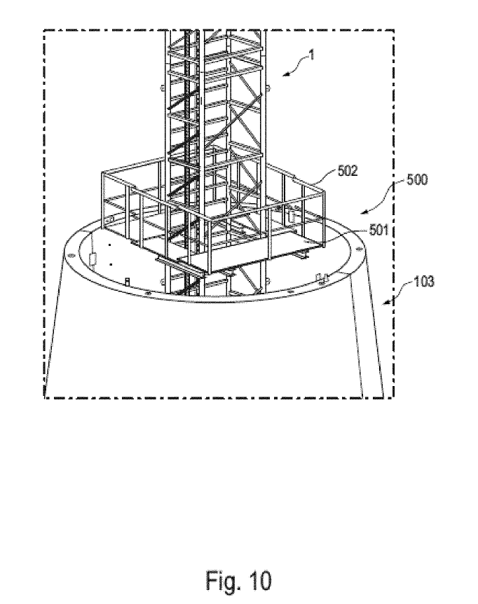

In the operational state, the supply scaffold 1 is arranged with a first scaffold module, which is in the form of a floor module, standing on a floor. In FIGS. 3 and 10, the supply scaffold 1 is arranged on a floor of a tower foot 103. In FIG. 4, an electrical module is firstly arranged on a tower foot 103, which electrical module forms the floor on which the supply scaffold 1 is arranged.

In FIG. 10, a platform 500 with a floor 501 and a railing 502 is arranged in an encircling fashion on the outer side of the supply scaffold 1, which platform may serve for accommodating persons and/or for the temporary storage of working means and/or tools. The platform 500 is preferably displaceable in a substantially vertical direction along the supply scaffold 1, such that the platform 500 can be utilized at varying heights. It is furthermore preferable for a substantially horizontal extent of the platform 500 to be variable, such that the platform 500 can be adapted to varying inner diameters of a tower, for example in the case of towers which taper in an upward direction.

The supply scaffold 1 has the advantage in particular that, owing to the standing arrangement of the scaffold modules on a floor of a tower, the supply scaffold 1 is already operationally ready even when the tower has not yet been erected to its full height. In this way, the supply scaffold 1 can be utilized already during the erection of the tower, in particular a sidewall 240 in the form of a ladder and/or an elevator module 400, 400′ and/or a platform 500. This can considerably reduce the need for an external crane and/or external lifting platforms already during the erection of the tower, or even render the use of such external lifting means entirely or partially superfluous. Furthermore, the compact and space-saving arrangement of the supply scaffold with supply elements in the interior of the tower permits a simpler and cost-saving arrangement of other tower interior fixtures, in particular on the tower interior wall, and/or of external tensioning cables.

1. A supply scaffold for arranging in an interior of a tower of a wind power installation, the supply scaffolding comprising:
a plurality of scaffold modules arranged stacked relative to one another and coupled together,
wherein, in an operational state of the supply scaffold, a first scaffold module of the plurality of scaffold modules is formed as a floor module and is arranged so as to stand on a floor of the tower or a base platform of the tower, and
wherein a second scaffold module of the plurality of scaffold modules is formed as a core module and is arranged on the floor module.

2. The supply scaffold as claimed in claim 1, wherein the supply scaffold is designed and arranged so as to be operated while the tower is being erected.

3. The supply scaffold as claimed in claim 1, wherein one or more of the plurality of scaffold modules has a framework-like lattice structure.

4. The supply scaffold as claimed in claim 1, wherein the floor module has an open sidewall.

5. The supply scaffold as claimed in claim 1, wherein the supply scaffold has a ladder or a climbing aid.

6. The supply scaffold as claimed in claim 1, wherein the supply scaffold has an elevator module.

7. The supply scaffold as claimed in claim 6,
wherein the elevator module is arranged in an interior of the supply scaffold, and
wherein the elevator module is arranged and designed such that at least one of persons or loads can be conveyed in the interior of the scaffold modules by the elevator module.

8. The supply scaffold as claimed in claim 6, wherein the supply scaffold has a riser device that engages with a riser element of the elevator module.

9. The supply scaffold as claimed in claim 8, wherein the supply scaffold has a drive configured to drive at least one of the riser device or the riser element.

10. The supply scaffold as claimed in claim 1, wherein at least one of:
the supply scaffold has one or more first fastening elements for fastening the supply scaffold to an interior wall of the tower,
the supply scaffold has one or more second fastening elements for fastening supply elements to a sidewall of the supply scaffold, or
the supply scaffold has a platform arranged displaceably on the supply scaffold.

11. A scaffold module for a supply scaffold, wherein the scaffold module is the floor module and is designed to be arranged so as to stand on the floor of the tower or a base platform of the tower, wherein in the operational state of the supply scaffold, or is a core module, which is designed to be arranged on a floor module in the operational state of the supply scaffold.

12. A tower comprising a supply scaffold as claimed in claim 1.

13. A wind power installation, comprising the tower as claimed in claim 12.

14. A method for erecting the supply scaffold as claimed in claim 1, the method comprising:
arranging the first scaffold module as the floor module so as to stand on the floor of the tower to be erected or the base platform of the tower to be erected,
arranging the second scaffold module as the core module on the floor module, and
setting the supply scaffold in operation while the tower is being erected.

15. A method for erecting a tower for a wind power installation, the method comprising:
providing a tower foot having a floor or having a base platform,
erecting and operating a supply scaffold as claimed in claim 1 in an interior of the tower foot, and
erecting the tower on the tower foot.

16. The supply scaffold as claimed in claim 9, wherein the drive is arranged on or in the elevator module.
